(19) United States
(12) Patent Application Publication
(10) Pub. No.: US 2010/0198424 A1
(43) Pub. Date: Aug. 5, 2010

(54) METHOD FOR RECONFIGURABLY CONNECTING PHOTOVOLTAIC PANELS IN A PHOTOVOLTAIC ARRAY

(76) Inventors: Toru Takehara, Foster City, CA (US); Shinichi Takada, Fremont, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/389,337

(22) Filed: Feb. 19, 2009

Related U.S. Application Data
(60) Provisional application No. 61/148,878, filed on Jan. 30, 2009.

(51) Int. Cl. G06F 1/26; H02J 1/10

(52) U.S. Cl. 700/298; 307/71; 700/297

(57) ABSTRACT

A method for controlling output from a photovoltaic array comprises changing electrical connections between photovoltaic panels in the array in response to changes in parameters related to a selected power transfer objective. Examples of power transfer objectives include matching array impedance to changes in electrical load impedance, outputting power at a maximum power point value, and maintaining array output voltage within the input voltage range of an inverter during changes in temperature, illumination, or other parameters affecting photovoltaic panel output. Photovoltaic panels adapted for reconfigurable electrical connections to other photovoltaic panels, referred to as intelligent nodes, are electrically interconnected according to the disclosed method in combinations of serial and parallel circuits selected according to measured and calculated values of parameters related to the selected power transfer objective. A photovoltaic array operating in accord with the disclosed method may be rapidly reconfigured to adapt to changes in measured parameters or changes from one power transfer objective to another.

### CROSS REFERENCE TO RELATED APPLICATIONS

This application claims the benefit of U.S. Provisional Application No. 61/148,878, filed Jan. 30, 2009.

### FIELD OF THE INVENTION

The present invention relates generally to a method for reconfiguring electrical connections between photovoltaic panels in a photovoltaic array and more specifically to a method for reconfigurably connecting photovoltaic panels in the photovoltaic array in a combination of serial and parallel electrical circuits selected according to a power transfer objective.

### BACKGROUND

For a photovoltaic (PV) cell operating under specified conditions for incident illumination and temperature, there is a particular combination of values for PV cell output voltage and output current at which an amount of electrical power generated by the PV cell is at a maximum. The maximum power output from the PV cell, referred to as the maximum power point (MPP) or P_{MAX}, varies in response to changes in incident illumination, changes in PV cell operating temperature, and changes in the impedance of an electrical load receiving power from the PV cell. A value for MPP may be determined for a PV panel which includes one or more PV modules, where each PV module includes many PV cells connected in an electrical circuit. Values for MPP may also be found for a PV array made from many PV panels, for a PV area including one or more PV arrays, and for a PV power generation system including one or more PV areas.

In many PV arrays currently in use, the PV panels in the PV array are mechanically and electrically arranged so that the PV array outputs power at the MPP when the array is operated under predetermined reference conditions for load impedance, temperature, and illumination. For example, the output voltage and output current from a solar PV array for converting sunlight to electricity may be chosen to deliver electrical power corresponding to the MPP for unobstructed sun exposure at a selected time of year and a selected time of day. However, since incident illumination changes as a result of the sun's seasonal and daily changes in position relative to the PV array, the current output of the PV array also changes, as does a related value of MPP. Illumination received by PV panels in the PV array is also affected by changes in the transmission of sunlight through the earth's atmosphere, for example by weather changes which reduce the amount of sunlight incident upon the PV array. Temperature changes, for example changes in ambient temperature and changes in direct solar heating of PV array components throughout the day or from season to season, also cause the power output from the PV array to deviate from the MPP. A PV array known in the art will usually output an amount of power which is less than the MPP as a result of illumination, temperature, or load impedance conditions which differ from the reference conditions for which the array was configured. A PV array which is not operating at the MPP may be wasting electrical power or may be risking damage to electrical or photovoltaic components in the array.

A solar PV power generation system for supplying alternating current (AC) power includes a power conversion apparatus, for example a DC-to-AC inverter, for converting direct current (DC) power from PV panels into AC output power to be supplied to an electrical load. Inverters sized for large electrical loads generally have a relatively narrow DC input voltage range and a minimum DC input voltage that is substantially higher than the output voltage of a single PV panel. A selected number of PV panels are therefore electrically connected in series to form a combined PV array output voltage within the DC input range for the inverter. A selected number of serially connected chains of PV panels are further connected in parallel in the PV array to provide a target value of output current. For PV arrays known in the art, the number of panels in each serially connected chain of PV panels and the number of chains of PV panels connected in parallel are fixed, that is, the electrical cables between PV panels are not disconnected and reconnected into a new circuit configuration during normal operation. Changing a configuration of serial and parallel electrical connections between PV panels in a PV array known in the art generally requires disconnecting and reconnecting many electrical cables, a labor- and time-intensive process. Configuration changes for PV arrays known in the art are generally impractical as a means of responding to transient phenomena such as short-term changes in the electrical load, short periods of high ambient temperature, cloudy conditions, and so on. Furthermore, when the output voltage from a PV array known in the art is less than a minimum input voltage specification for the inverter, output power from the array is no longer suitable for input to the inverter and is not used for powering an electrical load.

Some PV arrays have an output voltage and an output current selected for a target value of MPP related to selected reference conditions for incident illumination, temperature, and load impedance. Other PV arrays include means for adjusting output voltage or output current so that power output from the PV array remains close to the MPP as the MPP changes in response to changes in operating conditions. Since the PV array output voltage preferably remains within an inverter's relatively narrow DC input range, a PV array equipped to adjust its output to track a changing value of MPP generally does so by adjusting the array output current. A maximum power point tracker (MPPT) is an example of an electrical apparatus for adjusting PV array output current in response to a changing value of MPP. An MPPT adjusts the impedance of an electrical load connected to the PV array, thereby setting PV array output current to a value related to a new MPP value.

It is common practice to configure the combination of a PV array, MPPT, and inverter for operation with a constant value for load impedance. However, in practice the load impedance is generally not constant. Furthermore, the cost and complexity of an MPPT are high, especially for an MPPT made from semiconductor devices designed to be exposed to the high voltages and large currents present in the outputs from large PV arrays. MPPT cost and complexity increase rapidly as the size of a PV array increases, so it is not a simple matter to scale an MPPT or similar regulating apparatus to very large PV arrays, for example utility-scale PV arrays. Furthermore, complex electrical devices using semiconductors operated at high voltage and high current are known to reduce the overall reliability of the systems in which the devices operate. An MPPT which suffers an electrical fault could cause output from the entire PV array to be interrupted.

What is needed is a method for rapidly adjusting the configuration of serial and parallel electrical connections between PV panels in a PV array to supply electric power to an electrical load according to one or more objectives for power transfer, for example an objective of tracking changes in MPP or an objective of matching PV array impedance to load impedance. What is further needed is a method that is economically scalable to very large PV arrays, for example, utility-scale PV arrays. What is also needed is a method for adjusting the output of a PV array that reduces the likelihood that a single-point equipment failure will interrupt power output from the PV array.

### SUMMARY

A method is provided for selecting a combination of serial and parallel electrical connections between PV panels according to a selected power transfer objective for electrical power output from a PV array to an electrical load. A PV panel suitable for use with the disclosed method is referred to herein as an intelligent node. Two or more electrically connected intelligent nodes are referred to herein as a configurable PV array. In some examples of the method, a combination of serial and parallel connections between intelligent nodes is selected according to a power transfer objective related to equalizing impedances for the electrical load and configurable PV array. In other examples of the method, a combination of serial and parallel connections between intelligent nodes is selected according to a power transfer objective related to output of the power from the configurable PV array at the maximum power point. In other examples, the combination of serial and parallel connections in a configurable PV array is determined according to other power transfer objectives.

According to the disclosed method, a combination of serial and parallel electrical connections between intelligent nodes in a configurable PV array may optionally be changed to a different combination of serial and parallel connections in response to changes in the values of one or more parameters related to the power transfer objective. A change from one PV array configuration to another PV array configuration is accomplished by setting switching states for electrically controlled switches included in each intelligent node. A change from one PV array configuration to another PV array configuration may be controlled by a central monitoring and control computer system or may alternatively be controlled by an intelligent node designated for the purpose. Commands may be sent to the intelligent nodes over one or more communications interfaces, either sequentially or simultaneously.

This section summarizes some features of the present invention. These and other features, aspects, and advantages of the invention will become better understood with regard to the following description and upon reference to the following drawings, wherein:

### BRIEF DESCRIPTION OF THE DRAWINGS

FIG. 1 is a block diagram illustrating steps in an example of a method in accord with the present invention.

FIG. 2 is a schematic diagram of an example of a photovoltaic panel referred to herein as an intelligent node. The intelligent node example of FIG. 2 is adapted for selectable serial or parallel electrical connections with other intelligent nodes, includes a bypass circuit, and is further adapted for exchange of data and commands with other intelligent nodes and with a central control and monitoring computer system.

FIG. 3 is a simplified schematic diagram of an integer number “n” of the intelligent nodes of FIG. 2 interconnected with cable assemblies in a serial electrical circuit.

FIG. 4 is a simplified schematic diagram of an integer number “n” of the intelligent nodes of FIG. 2 interconnected with cable assemblies in a parallel electrical circuit.

FIG. 5 is a simplified schematic diagram of an example of a simple PV array having three of the intelligent nodes of FIG. 2 interconnected with serial and parallel electrical connections.

FIG. 6 is a schematic diagram of an example of a PV array having twelve of the intelligent nodes of FIG. 2 in an electrical circuit with an inverter and an electrical load. The electrical load in the example of FIG. 6 is representative of an electrical load whose impedance Z_{LOAD} changes during operation of the PV array. The PV array example of FIG. 6 may be selectively configured as in any of the examples of FIG. 7-12 according to settings chosen for series-parallel selectors X1-X12.

FIG. 7 is a schematic diagram for an example of one of many possible selectable electrical configurations for the PV array example of FIG. 6. In the example of FIG. 7, all of the intelligent nodes in the PV array are electrically connected in parallel.

FIG. 8 is a schematic diagram showing the PV array example of FIG. 6 configured as two groups of intelligent nodes electrically connected in series, with six intelligent nodes electrically connected in parallel in each group.

FIG. 9 is a schematic diagram showing the PV array example of FIG. 6 configured as three groups of intelligent nodes electrically connected in series, with four intelligent nodes electrically connected in parallel in each group.

FIG. 10 is a schematic diagram showing the PV array example of FIG. 6 configured as four groups of intelligent nodes electrically connected in series, with three intelligent nodes electrically connected in parallel in each group.

FIG. 11 is a schematic diagram showing the PV array example of FIG. 6 configured as six groups of intelligent nodes electrically connected in series, with two intelligent nodes electrically connected in parallel in each group.

FIG. 12 is a schematic diagram showing the PV array example of FIG. 6 with all of the intelligent nodes electrically connected in series.

FIG. 13 is an example of a variation of the method of FIG. 1. In the example of FIG. 13, steps are shown for a power transfer objective of maintaining configurable PV array output voltage within the DC voltage input range for a DC-to-AC inverter.

FIG. 14 is an example of another variation of the method of FIG. 1. In the example of FIG. 14, steps are shown for a power transfer objective of equalizing the impedance of the configurable PV array and the impedance of an electrical load equal.

FIG. 15 is a first part of an example of another variation of the method of FIG. 1. In the example of FIG. 15, steps are shown for a power transfer objective of operating the configurable PV array at the maximum power point (MPP).

FIG. 16 is a continuation of the example of FIG. 15.

### DESCRIPTION

A method is provided for efficiently transferring electrical power from a photovoltaic (PV) array to an electrical load connected to the PV array by configuring connections between PV panels in the PV array in selectable combinations of serial and parallel electrical circuits. In related variations of the disclosed method, power is transferred according a selected power transfer objective. A power transfer objective is a target, guideline, or principle for determining a preferred electrical configuration of a PV array. In some cases, a power transfer objective is not fully attainable but may be approached by an optimum selection of PV array parameters. For example, in one variation, the power transfer objective is to maintain a value of output voltage from the configurable PV array within the limiting values of a DC input range specification for a DC to AC inverter. In another variation, the power transfer objective is to transfer power from the PV array to the electrical load at the maximum power point (MPP). In another variation, the power transfer objective is to cause the impedance of the PV array and the impedance of the electrical load to differ by less than a specified maximum amount of error. In yet another variation, the power transfer objective is to rapidly adapt a PV array to changes in incident illumination, temperature, or other specified parameters. Other variations of the method seek optimizations based on a combination of power transfer objectives.

Examples of a PV panel suitable for use with the examples disclosed herein are referred to as intelligent nodes. Examples of intelligent nodes are described in U.S. patent application Ser. No. 12/243,890, filed Oct. 1, 2008 with the title “Network Topology for Monitoring and Controlling a Solar Panel Array”, incorporated herein by reference, and U.S. patent application Ser. No. 12/352,510, filed Jan. 12, 2009 with the title “System for Controlling Power From A Photovoltaic Array By Selectively Configuring Connections Between Photovoltaic Panels”, incorporated herein by reference.

Advantages of the disclosed method include economical and efficient control of power transfer from PV arrays of fewer than a hundred PV panels to utility-scale PV arrays with hundreds of thousands of PV panels. Another advantage is rapid reconfiguration of serial and parallel electrical connections for adapting a PV array to changes in operating conditions. For example, in a PV array having 100,000 intelligent nodes communicating with a central monitoring and control computer by a relatively slow wireless link, electrical connections to every panel in the array could be electrically switched to a new configuration in less than five minutes. In many cases, a change in configuration will not require a change in connections to every panel, so even with a relatively slow communications link to PV panels in the PV array, configuration changes would generally be fast enough to track many transient phenomena encountered during PV array operation. It is therefore practical to reconfigure a PV array by the disclosed method in response to moving cloud shadows, shadows from structures that change position as the sun changes position in the sky, changes in electrical load, weather changes, PV panel failures, PV panel maintenance, and so on. Furthermore, in a large PV array, much of the data sent to individual PV panels would travel over relatively high speed data pathways, reducing time needed for reconfiguring the array from a few minutes to a few seconds.

In some variations of the method, the larger the PV array, the more closely outputs from the PV can be made to approach conditions related to a selected power transfer objective. For example, in some variations of the method, the larger the PV array, the more closely the impedance of the PV array can be made to approach the impedance of an electrical load receiving power from the array. In other variations, the larger the PV array, the more closely the PV array can be made to approach a changed value of MPP related to a change in operating temperature or incident illumination. Other advantages include formation of serial and parallel electrical connections between PV panels in a PV array without exposing semiconductor components to high voltage or high current and elimination of some electrical equipment having the potential to cause a single point failure. Improved system reliability compared to PV power generation systems known in the art is another advantage. Furthermore, the disclosed method may be followed during normal operation of a PV array, that is, the array can be reconfigured from one combination of serial and parallel connections to another without disconnecting and reconnecting electrical cables. Another advantage is improving the efficiency of power transfer from a PV array to an electrical load receiving power from the array.

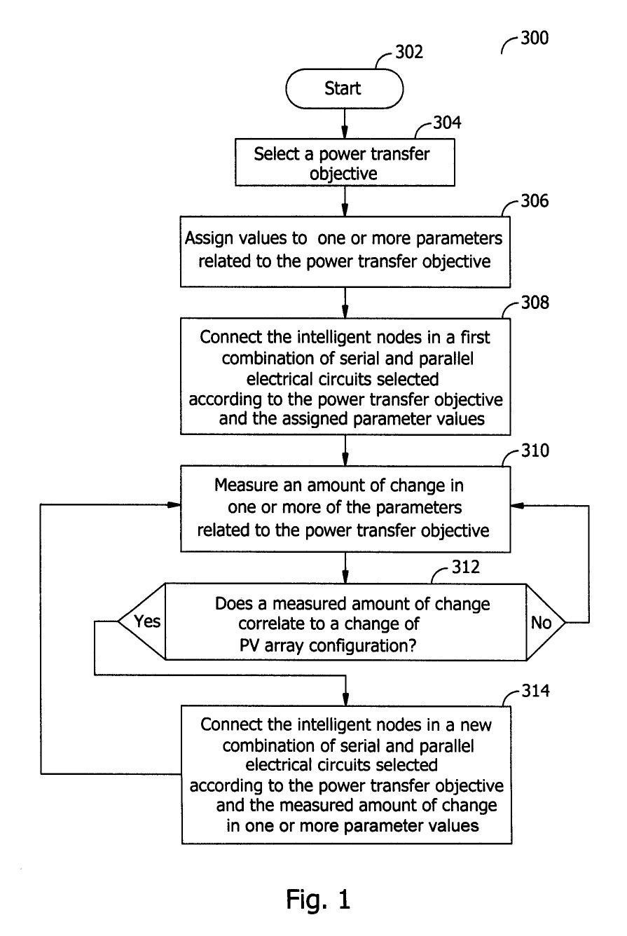

An example of a method in accord with the invention is shown in FIG. 1. The example of the method 300 in FIG. 1 begins at step 302. In step 304, a power transfer objective for power output by a configurable PV array to an electrical load is selected. Subsequent steps in the method depend on parameters and conditions related to the selected power transfer objective.

The example of the method 300 in FIG. 1 continues with step 306, in which values are assigned to parameters related to the power transfer objective. Values may optionally be assigned by measurement of parameter values, for example, but not limited to, configurable PV array output voltage, configurable PV array output current, PV array impedance, electrical load impedance, average value of illumination incident on intelligent nodes in the configurable PV array, or other selected parameters. Alternatively, parameter values may be assigned as the result of calculations using target values related to reference conditions for illumination, temperature, load impedance, or other selected parameters related to a power transfer objective. Or, some parameters may be assigned values by calculation and other parameters may be assigned values by measurement.

Next, in step 308, a first combination of serial and parallel electrical connections between intelligent nodes is selected according to the power transfer objective selected in step 304 and the parameter values assigned in step 306. The first combination of serial and parallel connections is referred to herein as a baseline configuration for the configurable PV array. Variations in parameter values related to the power transfer objective optionally result in the PV array being changed from the baseline configuration to a new configuration. In step 308, after selecting a combination of serial and parallel connections between intelligent nodes, the intelligent nodes are electrically interconnected according to the selected combination.

In step 310, an amount of change is measured for one or more parameters related to the power transfer objective. For example, in some variations of the method, load impedances are measured at different times and an amount of change in load impedance is determined. Then, in step 312, the measured amount of change is evaluated to determine if the configuration of the PV array should be changed. If the amount of change in a parameter correlates more closely with a new PV array configuration than with the current PV array configuration, then in step 314, connections between the intelligent nodes are reconfigured according to the new PV array configuration related to the changed parameter values from step 312. If the amount of change in one or more parameters does not correlate to a new PV array configuration, the method returns to step 310 to measure new values for one or more parameters. One will appreciate that, although no explicit termination step is shown for the example of a method 300 illustrated in FIG. 1, the method may optionally be interrupted at any selected step.

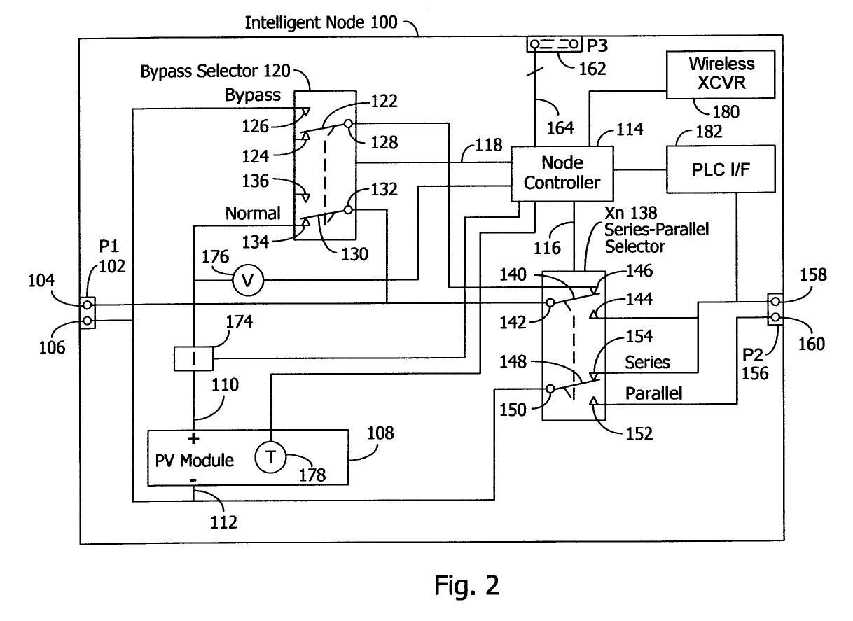

Methods in accord with the invention are directed at a configurable PV array which includes two or more intelligent nodes. A circuit diagram for an example of an intelligent node is shown in FIG. 2, which is a representation of the intelligent node disclosed in application Ser. No. 12/352,510, wherein the intelligent node is referred to as a configurable PV panel, and the communications, monitoring, and control features disclosed for an intelligent node in application Ser. No. 12/243,890. The intelligent node 100 of FIG. 2 includes a PV module 108 for generating electrical power from solar radiation, a node controller 114 for monitoring and controlling the intelligent node 100, and an electrically controlled bypass selector 120 for selectively excluding current and voltage output from the PV module 108 from current and voltage on a first power connector P1 102. The intelligent node 100 of FIG. 2 further includes a second power connector P2 156 and an electrically controlled series-parallel selector Xn 138 for selectively connecting to other intelligent nodes 100 with serial electrical connections, parallel electrical connections, or a combination of serial and parallel electrical connections.

The intelligent node 100 of FIG. 2 includes a node controller 114 adapted for communication with other nodes, a gateway, or a central monitoring and control computer. A node controller may include, for example but not limited to, an electrical circuit comprising a plurality of discrete circuit components, a programmable logic array, a gate array, an application-specific integrated circuit, or a microprocessor or microcontroller with associated support circuits. A gateway is an optional network communications device which collects data from a group of intelligent nodes before forwarding the data to the central monitoring and control computer. Also, commands received from the central monitoring and control computer are optionally distributed to the group of intelligent nodes by the gateway.

The node controller 114 of FIG. 2 transmits and receives data and commands by any of several redundant means of communication. More than one means of communication may optionally be used to exchange data and commands with other equipment. For example, the intelligent node may optionally be equipped with a control and monitoring interface connector P3 162 electrically connected to the node controller 114 by a plurality of electrical lines 164 for wired communications with other equipment. The intelligent node may optionally include a power line communication interface (PLC I/F) 182 electrically connected to a bidirectional communication port of the node controller 114 and electrically coupled through circuitry included in the PLC interface 182 to connector P2 156. A wireless transceiver (XCVR) 180 may also optionally be provided for exchange of data and commands. The wireless XCVR 180 is electrically connected to a bidirectional communication port on the node controller 114 and exchanges signals representative of data and commands with other wireless transceivers, for example wireless transceivers in other intelligent nodes or gateways. Under some circumstances, for example when a gateway is not in operation, an intelligent node may optionally exchange data and commands by wireless communication with a central monitoring and control computer. A wireless transceiver 180 adapted for short range communication, for example a Bluetooth transceiver, may be included in the intelligent node 100. Alternatively, a transceiver for long range communication may be included, for example a Wifi transceiver or a transceiver using other wireless communication technology.

The node controller 114 in FIG. 2 monitors parameters related to the performance of the PV module 108 and intelligent node 100 and sets a switching state of the bypass selector 120 and a separate switching state of the series-parallel selector Xn 138. Examples of parameters monitored by the node controller include, but are not limited to, PV module 108 output current, measured by a current measurement circuit 174, PV module 108 output voltage, measured by a voltage measurement circuit 176, one or more PV module temperatures, measured by one or more temperature measurement circuits 178, azimuth and elevation angles of the PV module 108, current and voltage on the second power connector P2 156, and current and voltage on the first power connector P1 102. The node controller 114 may optionally be configured to detect electrical fault conditions within the PV module 108 or the intelligent node 100, partial shading of the PV module 108, reductions in electrical power from precipitation, dust, or debris on a surface of the PV module 108, and reductions in incident radiation from dust in the air, precipitation, or cloud cover. The node controller 114 may also optionally be configured to monitor other sensors such as sensors for monitoring PV module surface reflectivity, incident light intensity, PV module azimuth and elevation angles, and may be adapted to control actuators such as azimuth and elevation motors for tracking the sun's position.

Switching states for the electrically controlled bypass selector 120 and the electrically controlled series-parallel selector Xn 138 determine how current and voltage output from the PV module 108 is combined with electrical power flowing through the first and second power connectors P1 102 and P2 156. As shown in FIG. 2, the bypass selector 120 and the series-parallel selector Xn 138 are preferably double-pole, double-throw (DPDT) electromechanical relays. Either one or both of the selectors (120, 138) may alternatively be replaced by a solid state relay or solid state switching devices made from discrete electronic components. Either selector (120, 138) may optionally be changed from a single DPDT electrically controlled switching device to a pair of single-pole, single-throw switching devices sharing a common control line electrically connected to the node controller 114.

Referring to FIG. 2, electric power from other intelligent nodes in a configurable PV array may optionally be connected to the intelligent node 100 on the second power connector P2 156 comprising a first terminal 158 and a second terminal 160. Voltage and current on the P2 first terminal 158 and the P2 second terminal 160 are selectively combined with voltage and current output from the PV module 108 according to selected switching states for the bypass selector 120 and the series-parallel selector Xn 138 as will be explained later. The P2 first terminal 158 is electrically connected to a parallel terminal 144 of a first S-P switch 140 in the series-parallel selector Xn 138. The P2 first terminal 158 is further electrically connected to a series terminal 154 of a second S-P switch 148 in the series-parallel selector Xn 138. The P2 second terminal 160 is electrically connected to a parallel terminal 152 of the second S-P switch 148.

A series terminal 146 of the first S-P switch 140 is electrically connected to a common terminal 128 for a first bypass switch 122 in the bypass selector 120. A common terminal 142 of the first S-P switch 140 is electrically connected to a common terminal 132 for a second bypass switch 130 in the bypass selector 120. The common terminal 142 of the first S-P switch 140 is further connected electrically to a connector P1 first terminal 104. A common terminal 150 of the second S-P switch 148 is electrically connected to a negative terminal 112 on the PV module 108, to a connector PI second terminal 106, and to a bypass terminal 126 of the first bypass switch 122 in the bypass selector 120.

Continuing with FIG. 2, a positive terminal 110 of the PV module 108 is connected electrically to an input of the current measurement circuit 174. An output of the current measurement circuit 174 is electrically connected to a normal terminal 134 of the second bypass switch 130 in the bypass selector 120. A bypass selector control line 118 carries control signals from the node controller 114 to a control input of the bypass selector 120. A first control signal from the node controller 114 on the bypass selector control line 118 sets the bypass selector 120 to a “Bypass” switching state in which output from the PV module 108 is excluded from the voltage and current on the terminals of the first power connector P1 102. A “Bypass” switching state is also referred to herein as a “B” switching state. A second control signal from the node controller 114 on the bypass selector control line 118 sets the bypass selector 120 to a “Normal” switching state in which output from the PV module 108 is selectively combined with the voltage and current on the terminals of the connector P1 102 according to one of two alternate switching states for the series-parallel selector Xn 138. A “Normal” switching state is also referred to herein as an “N” switching state. In the example of FIG. 2, the first bypass switch 122 and the second bypass switch 130 in the bypass selector 120 are shown in the “Normal” switching state. FIG. 2 further shows the first bypass switch 122 normal terminal 124 and the second bypass switch 130 bypass terminal 136 as unterminated. One skilled in the art will appreciate that passive components may optionally be electrically connected to the unterminated terminals to reduce an amount of noise coupled into the circuit.

A series-parallel selector control line 116 carries control signals from the node controller 114 to a control input of the series-parallel selector Xn 138. A third control signal from the node controller 114 on the series-parallel selector control line 116 sets the series-parallel selector Xn 138 to a “Series” switching state, also referred to herein as an “S” switching state. A fourth control signal from the node controller 114 on the series-parallel selector control line 116 sets the series-parallel selector Xn 138 to a “Parallel” switching state, also referred to herein as a “P” switching state. In the example of FIG. 2, the first S-P switch 140 and the second S-P switch 148 in the series-parallel selector Xn 138 are shown in the “Series” switching state.

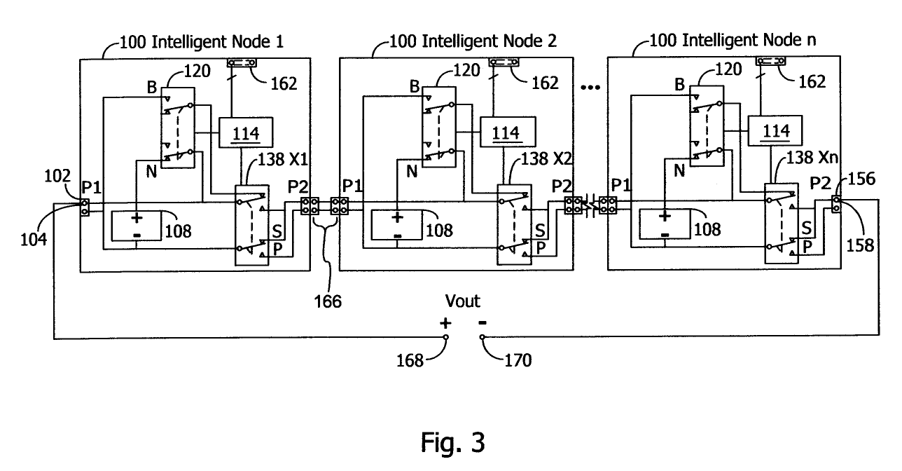

FIG. 3 illustrates an example of a configurable PV array having an integer number “n” of intelligent nodes 100 electrically connected in series by cable assemblies 166. As shown in FIG. 3, series-parallel selectors (138 X1, 138 X2, . . . 138 Xn) are shown in an “S” switching state. All of the bypass selectors 120 in the “n” number of panels are set to an “N” switching state in the example of FIG. 3. An output voltage Vout from the PV array, measured from a PV array negative output terminal 170 to a PV array positive output terminal 168, is the sum of the output voltages of the “n” intelligent nodes. In the configuration shown in FIG. 3, an output voltage for the configurable PV array further corresponds to the PV array output voltage Vout measured from a connector P2 terminal 1 158 in intelligent node number “n” to a connector P1 terminal 1 104 in intelligent node number 1. In the case of an intelligent node having the series-parallel selector set to the “S” state and the bypass selector 120 set to the “B” state, output voltage from the intelligent node's PV module is excluded from the output voltage Vout by a circuit path in the intelligent node around the PV module between the first power connector P1 and the second power connector P2.

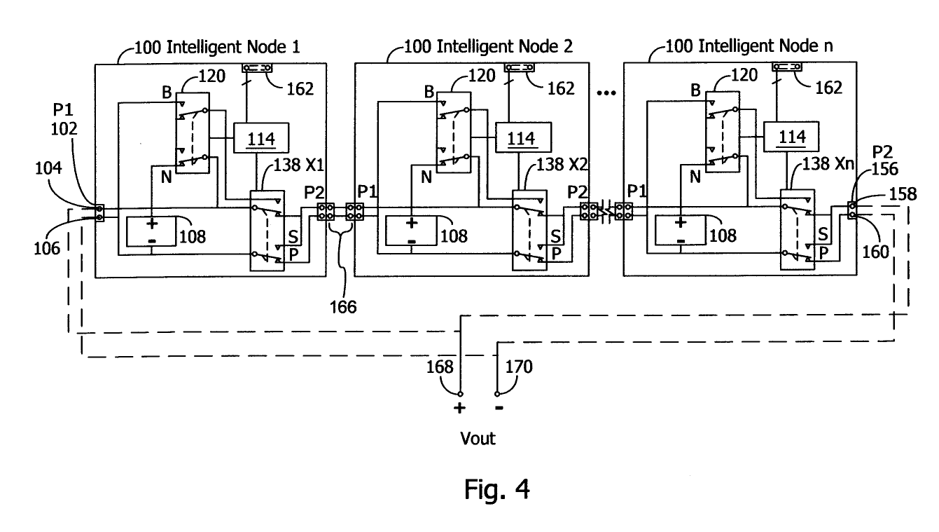

FIG. 4 illustrates one of many alternative electrical configurations for the “n” number of intelligent nodes electrically connected to form a configurable PV array in the example of FIG. 2. In FIG. 4, an integer number “n” of intelligent nodes 100 are electrically interconnected by cable assemblies 166 in a parallel electrical configuration with series-parallel selectors (138 X1, 138 X2, . . . 138 Xn) in a “P” switching state. Bypass selectors 120 are shown in an “N” switching state. An output voltage Vout from the configurable PV array, measured from a PV array negative output terminal 170 to a PV array positive output terminal 168, is equal to an output voltage from any one of the intelligent nodes 100 all of which, for purposes of this example, have equal output voltages. In the case of intelligent nodes having different output voltages, a PV array output voltage may be calculated by conventional methods for analyzing parallel electrical circuits. An output current from the configurable PV array example of FIG. 4 is equal to the arithmetic sum of the current output from each of the “n” number of intelligent nodes, an optional current input to connector P1 on intelligent node 100 number 1, and an optional current input to connector P2 on intelligent node 100 number “n”. PV array negative output terminal 170 may alternately be electrically connected to connector P2 terminal 2 160 on intelligent node 100 number “n” or to connector P1 terminal 2 106 on intelligent node 100 number 1, as indicated by dashed connection lines in FIG. 4. PV array positive output terminal 168 may alternately be electrically connected to connector P1 terminal 1 104 on intelligent node number 1 or to connector P2 terminal 1 158 on intelligent node number “n” as indicated by dashed connection lines in FIG. 4.

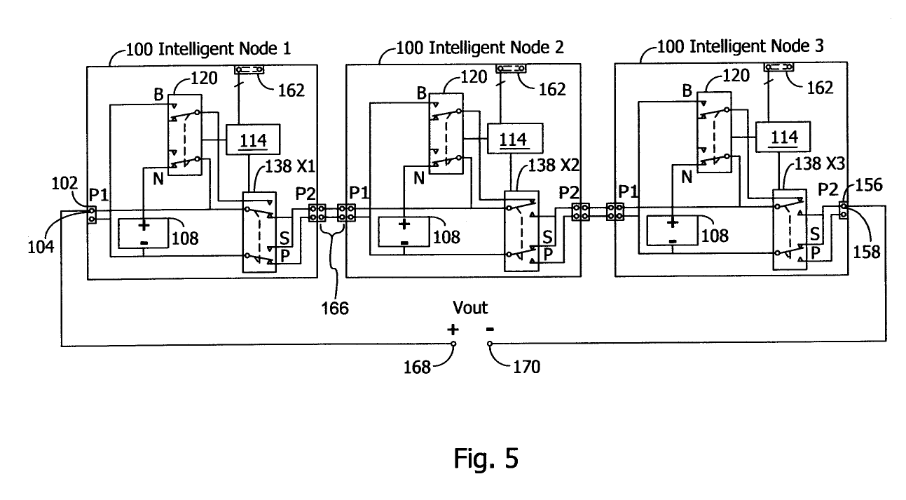

FIG. 5 shows an example of a configurable PV array including three intelligent nodes connected in a combination of serial and parallel electrical connections. In the example of FIG. 5, intelligent node 100 number 1 has a series-parallel selector 138 X1 set to a “P” switching state. The series-parallel selector 138 X2 in intelligent node 100 number 2 is in an “S” switching state, and intelligent node number 3 has a series-parallel selector 138 X3 set to an “S” switching state. A PV array output voltage Vout measured between the PV array positive output terminal 168 and the PV array negative output terminal 170 in FIG. 5 is approximately twice the PV array output voltage for intelligent nodes connected in parallel as shown in the example of FIG. 4. A PV array configured as in FIG. 5 will therefore produce an output voltage that is greater than or equal to the minimum input voltage for an inverter under lower levels of illumination than the PV array example of FIG. 4. A configurable PV array having selectable serial and parallel connections between intelligent nodes, as in the example of FIG. 5, captures electrical power for output to an electric power grid under conditions in which intelligent nodes interconnected only in parallel output power at too low a voltage for connection to an inverter input.

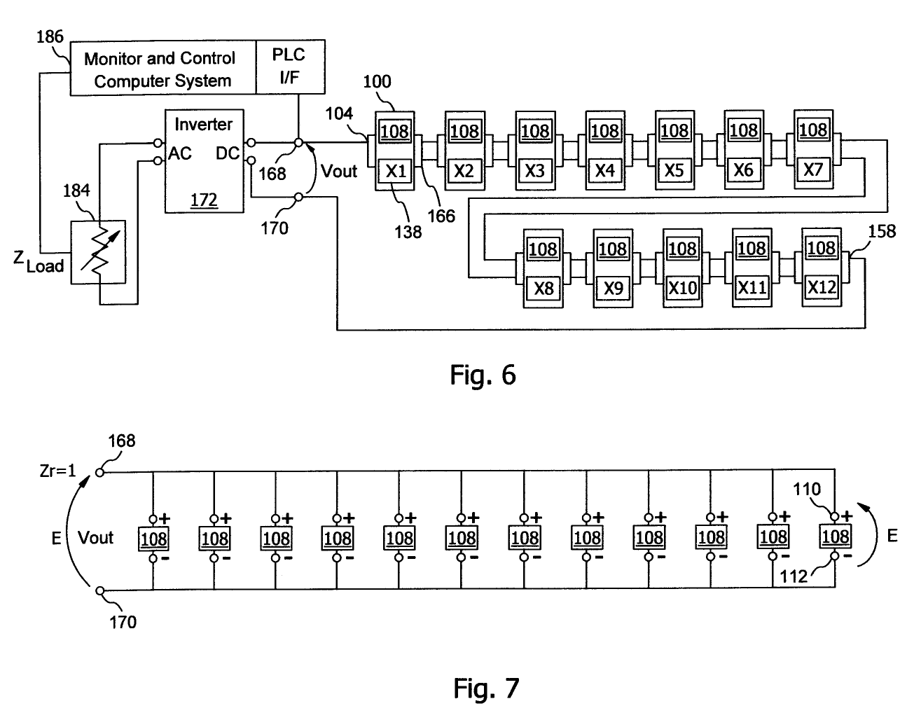

The example of FIG. 6 may be used to illustrate examples of combinations of serial and parallel electrical connections and corresponding configurable PV array output voltages produced by a configurable PV array having twelve intelligent nodes. FIG. 6 further illustrates an example of an electrical load connected to the configurable PV array, wherein the electrical load has impedance which may vary with time, and a monitoring and control computer system adapted to receive a signal related to load impedance. The monitoring and control computer system may optionally use the value of load impedance to select a combination of serial and parallel connections in the configurable PV array, or the combination may be selected by an intelligent node designated for the purpose.

Differences in output voltages between any two configurations of the configurable PV array correspond to differences in PV array impedance, as previously explained. An output voltage Vout from the configurable PV array is measured across a PV array positive output terminal 168 and a PV array negative output terminal 170. Connector P1 terminal 1 104 on intelligent node 100 number 1 is electrically connected to PV array positive output terminal 168, which is further electrically connected to a first DC input on an inverter 172. Connector P2 terminal 1 158 on intelligent node 100 number 12 is electrically connected to PV array negative output terminal 170, which is further electrically connected to a second DC input on the inverter 172. Each of the intelligent nodes 100 represented in simplified form in FIG. 6 includes a PV module 108 and a series-parallel selector (X1, X2, X3, . . . X12).

In a first alternative configuration illustrated in the simplified equivalent electrical circuit of FIG. 7, the twelve intelligent nodes of the example of FIG. 6, represented in FIG. 7 by PV modules 108, are connected in a parallel electrical circuit. An output voltage from a PV module 108, measured across a positive terminal 110 and a negative terminal 112, is represented by a voltage “E”. For the parallel electrical configuration of FIG. 7, corresponding to a “P” switching state selected for all twelve series-parallel selectors (X1-X12), the output voltage Vout of the configurable PV array, measured across the first and second output terminals (168, 170) is equal to “E”.

Table 1 summarizes the switching states for the twelve series-parallel selectors in the examples of FIGS. 6-12.

TABLE 1
“S” and “P” switching states corresponding to PV array output voltage Vout.

| FIG. | X1 | X2 | X3 | X4 | X5 | X6 | X7 | X8 | X9 | X10 | X11 | X12 | Vout |
|---|---|---|---|---|---|---|---|---|---|---|---|---|---|
| 6 | P | P | P | P | P | P | P | P | P | P | P | P | E |
| 7 | P | P | P | P | P | S | P | P | P | P | P | S | 2E |
| 8 | P | P | P | S | P | P | P | S | P | P | P | S | 3E |
| 9 | P | P | S | P | P | S | P | P | S | P | P | S | 4E |
| 10 | P | S | P | S | P | S | P | S | P | S | P | S | 6E |
| 11 | S | S | S | S | S | S | S | S | S | S | S | S | 12E |

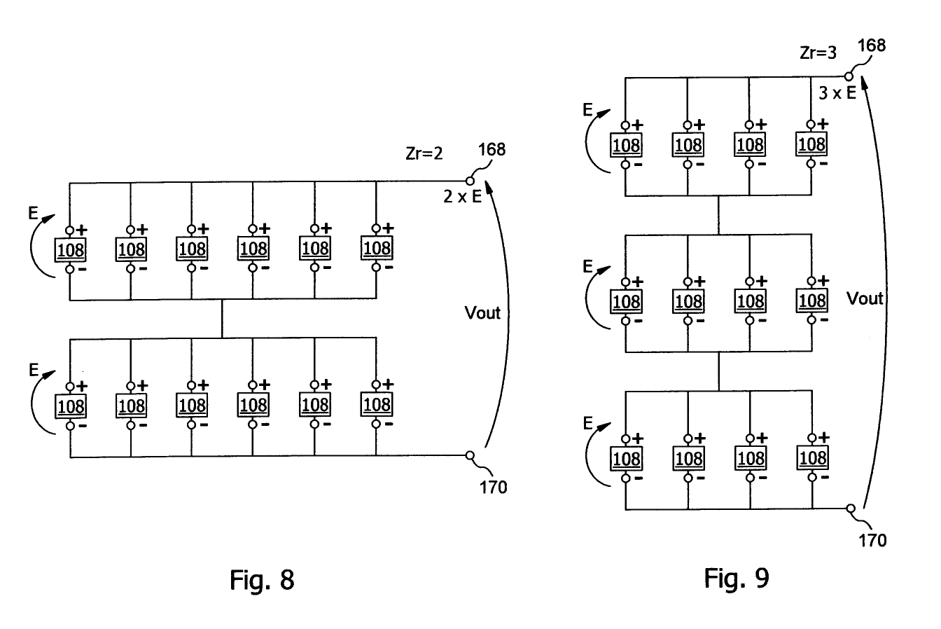

FIGS. 8-12 illustrate more alternative electrical configurations for the example of FIG. 6. FIG. 8 shows an equivalent electrical circuit for two serially connected groups with six intelligent nodes connected in parallel in each group. The PV array configuration of FIG. 8 has an output voltage across the first and second PV array output terminals (168, 170) of 2×E, where “E” is defined as for FIG. 7. Switch states for the twelve series-parallel selectors in the PV array are shown in Table 1.

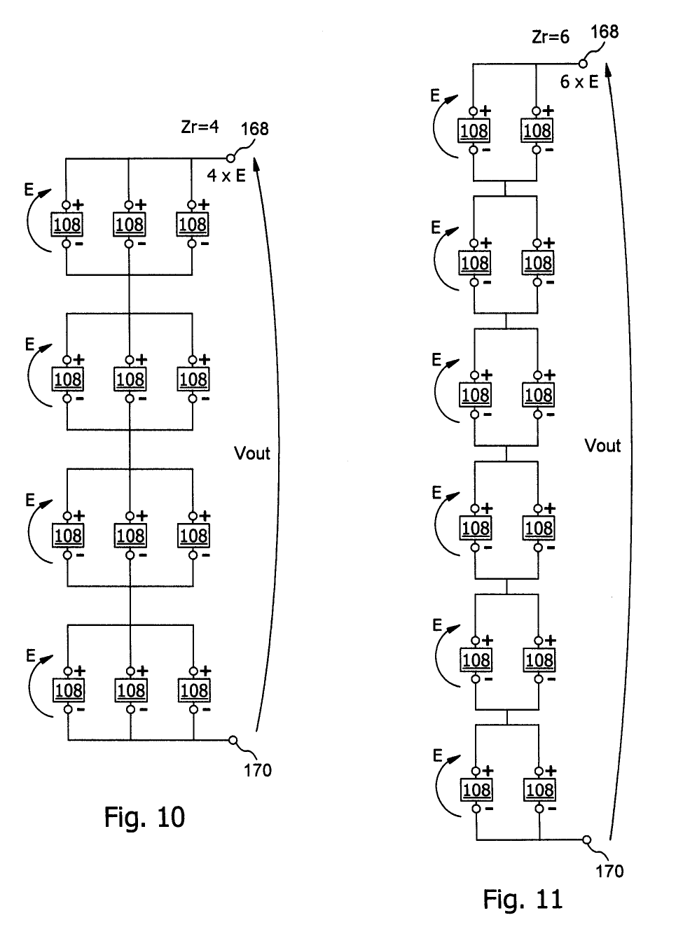

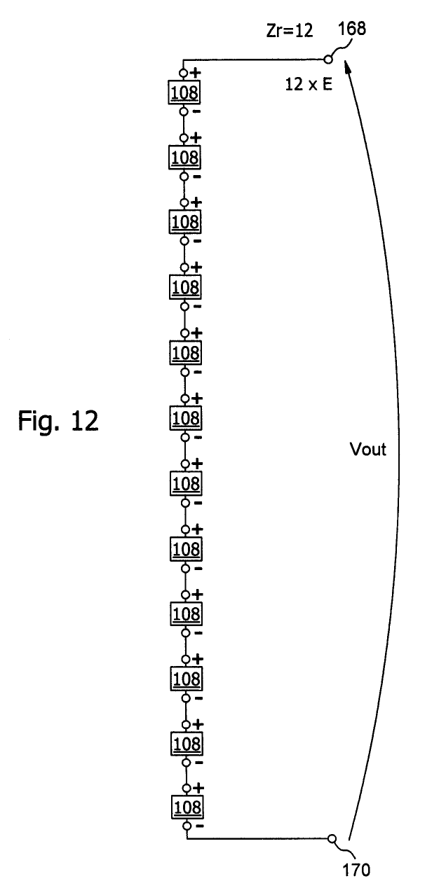

FIG. 9 shows an equivalent electrical circuit for three serially connected groups with four intelligent nodes connected in parallel per group and a PV array output voltage Vout equal to 3×E. FIG. 10 shows four serially connected groups having three intelligent nodes in parallel per group and a PV array output voltage of 4×E. A PV array output voltage Vout equal to 6×E is achieved by the configuration illustrated in FIG. 11, which shows six serially connected groups, each group having two intelligent nodes in parallel. Lastly, FIG. 12 shows a configuration having the maximum value of PV array output voltage. In FIG. 12, all twelve intelligent nodes are connected in series.

The examples of FIGS. 6 to 12 may be extended to very large configurable PV arrays comprising many hundreds or even many thousands of intelligent nodes. In some very large configurable PV arrays, an inverter having a high value for minimum DC input voltage is preferred. For example, in one example of a grid-connected inverter known in the art, the minimum DC input voltage is approximately fifteen times the voltage output from a single intelligent node. That is, at least fifteen intelligent nodes are electrically connected in series to generate an output voltage large enough to input to the inverter. In such a case, a configurable PV array has many serially connected chains of intelligent nodes with the chains of intelligent nodes further connected in parallel to one another and to the inputs of an inverter.

Embodiments of the invention are suitable for use in very large PV arrays comprising a plurality of series-connected chains of configurable PV panels in a parallel electrical circuit. Operation of an embodiment in a large array may be compared to the operation in the examples described previously herein by substituting a serially connected chain of configurable PV panels for a single panel in an example. For example, each of the intelligent nodes in the examples of FIGS. 6 to 12, represented in the figures by a PV module 108, could optionally be replaced by a serially connected chain of intelligent nodes to model the behavior of a very large number of intelligent nodes in a PV array supplying power to an inverter with a high minimum input voltage.

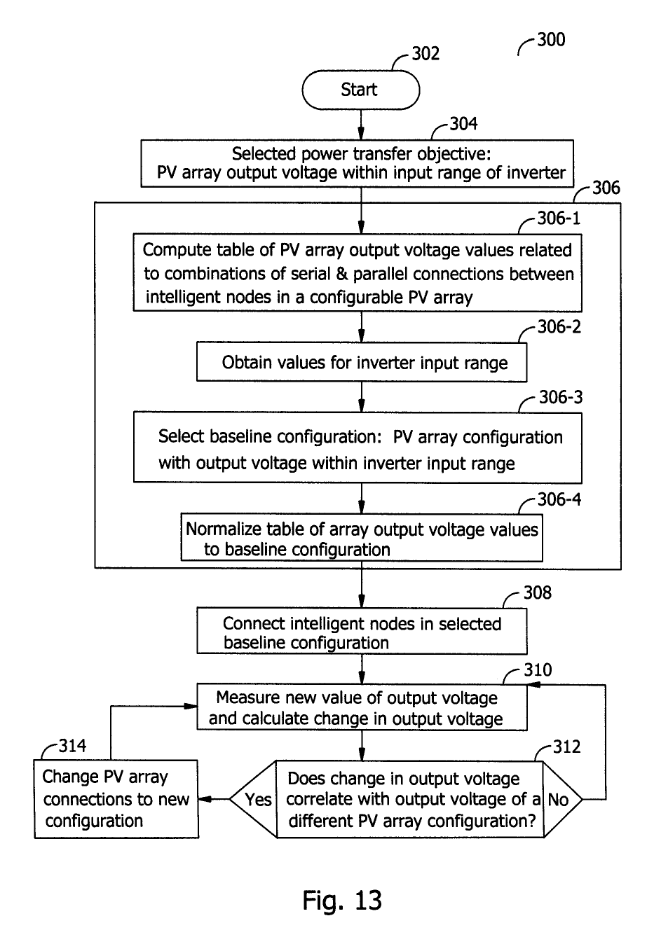

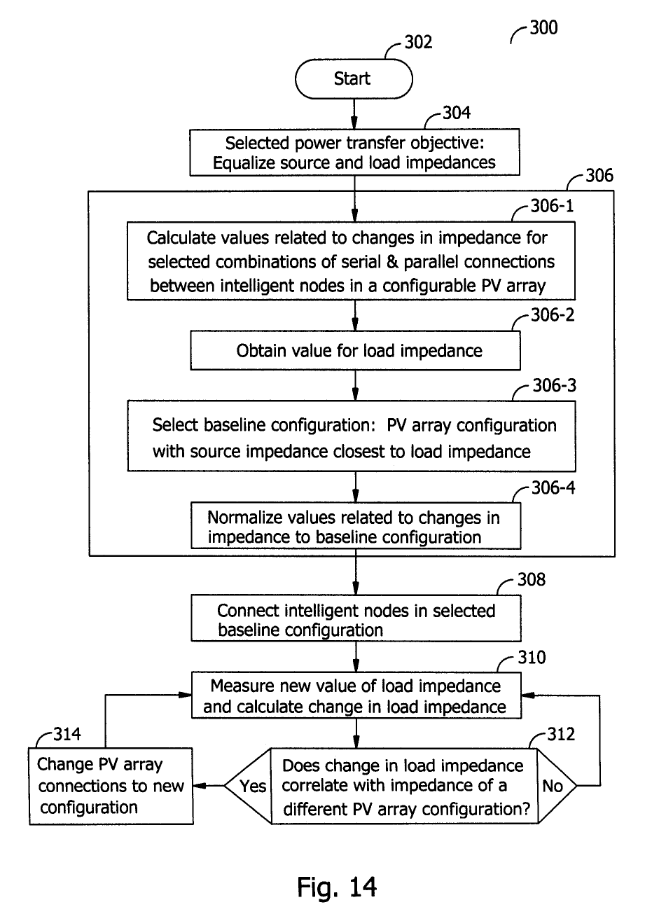

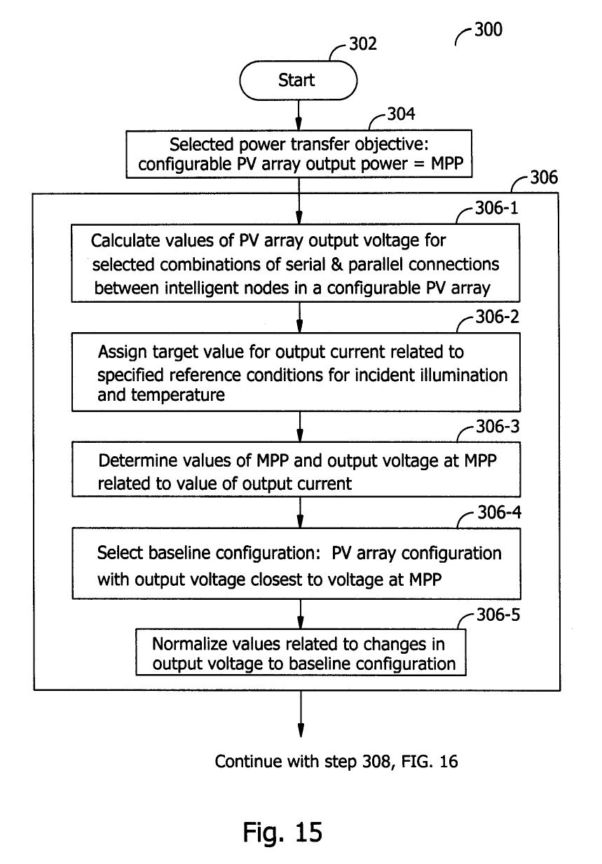

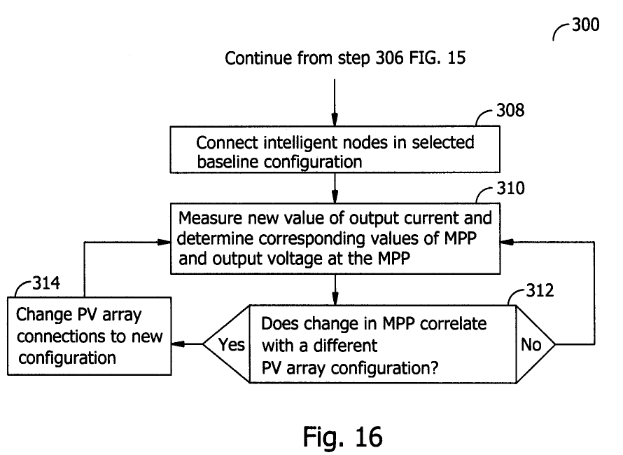

Connections between intelligent nodes adapted for connection to other intelligent nodes as described in the previous examples may be selectively configured according to different power transfer objectives. Examples of variations in the method of FIG. 1 are shown in FIGS. 13-16. FIG. 13 illustrates a variation in which the power transfer objective is to maintain a value for the configurable PV array output voltage within the DC voltage input range for a DC-to-AC inverter. FIG. 14 illustrates a variation in which the power transfer objective is to equalize source impedance and load impedance, where source impedance corresponds to PV array impedance, and load impedance. FIGS. 15-16 illustrate steps in a variation of the method in which the power transfer objective is to operate a configurable PV array at the MPP.

FIG. 13 illustrates an example of a variation of the method of FIG. 1 in which the selected power transfer objective is to generate a magnitude of PV array output voltage that is greater than or equal to the minimum DC input voltage for a DC to AC inverter and less than or equal to the maximum DC input voltage for the inverter. Numeric labels assigned to the steps in FIG. 13 indicate the corresponding steps shown in FIG. 1. The example of FIG. 13 begins at step 302 and proceeds to step 304, in which the power transfer method is selected. Such a selection may be implemented, for example, by presenting to a person responsible for managing a photovoltaic power generation system different options for power transfer objectives on a display device that is part of a central monitoring and control computer system.

In the example of FIG. 13, step 306 from FIG. 1 is shown to include steps 306-1 to 306-4. In step 306-1, a table of PV array output voltage values is calculated. Each entry in the table is related to an output voltage from a selected combination of serial and parallel electrical connections between intelligent nodes in a configurable PV array. In step 306-2, values are obtained for a minimum value and a maximum value for DC-to-AC inverter input voltage. The minimum and maximum input voltage values together define a DC input voltage range for the inverter.

One skilled in the art will understand that an inverter outputs AC voltage within a specified voltage range when a voltage value for electrical power input to the inverter is within the inverter's specified DC input voltage range. If input voltage is outside the specified input range, it may be necessary to disconnect an electrical load receiving power from the inverter outputs. For example, when an amount of illumination incident on a PV array decreases as a result of the sun's daily motion, the output voltage from a PV array will eventually fall below the minimum input voltage for an inverter. Subsequent power output from the array is wasted until illumination levels increase enough to generate power having a sufficient magnitude of voltage for supplying the inverter. A configurable PV array may therefore capture power that would be wasted by a PV array known in the art by reconfiguring serial and parallel electrical connections between intelligent nodes to increase the magnitude of output voltage from the array.

Continuing with FIG. 13, in step 306-3, a baseline configuration is selected for the configurable PV array. The baseline configuration in the example of FIG. 13 corresponds to a configuration having an output voltage determined in step 306-1 that is within the DC input voltage range for the inverter. In step 306-4, the table of values calculated in step 306-1 is optionally normalized to the value of output from the baseline configuration. Normalization is useful for quickly selecting a new PV array configuration that correlates to an amount of change in the PV array output voltage. Normalization and other calculations in the variations of the method described herein may alternatively be performed by the central monitoring and control computer system or by an intelligent node designated for the purpose.

The array of intelligent nodes is switched into the selected combination of serial and parallel connections in step 308. In step 310, the output voltage of the configurable PV array is measured again, and an amount of change from the previously measured value is calculated. In step 312, the amount of change in output voltage is compared to the minimum and maximum values for the inverter input range. If the new value of output voltage is outside the inverter input range, a new PV array configuration is selected to restore the output voltage to a value within the inverter input range. In step 314, the intelligent nodes in the configurable PV array are switched to the newly selected configuration. If instead the voltage from step 310 is still within the inverter input range, then step 312 returns to step 310 without changing the PV array configuration. The method illustrated in FIG. 13 is operative until all the intelligent nodes in the configurable PV array are electrically connected in series.

In FIG. 14, another example of a power transfer objective is to equalize source (i.e., configurable PV array) impedance and electrical load impedance. The power transfer objective in the variation of the method shown in FIG. 14 is related to the engineering principle that a maximum amount of electrical power may be transferred from a power source, for example a photovoltaic array, to an electrical load, for example the combination of an AC load and a DC-to-AC inverter supplying power to the AC load, when the impedance of the electrical load and the impedance of the power source are equal.

In general, impedance Z is related to resistance R and frequency ω by the well-known relationship in equation (1):

Z=R+iω (1)

For the photovoltaic cells in an intelligent node, the real term (R) in equation (1) predominates and the imaginary term (iω) may be ignored. The impedance Z of the PV module in an intelligent node may therefore be approximated by the combined resistances of the PV cells in the intelligent node, determined using Ohm's Law and measured values for the current output and voltage output for the DC power output from the intelligent node. The impedance Z for a PV array having many interconnected intelligent nodes may similarly be found by Ohm's Law using values for the output voltage E from the array and the output current I from the array as in equation (2):

Z≈R=E/I (2)

For a selected value of current I, changes in the impedance of a PV array made to match PV array impedance with load impedance are related to changes in the output voltage E of the PV array. As an example, FIGS. 7-12 are each labeled with a value “Zr” of impedance determined by equation 2 for each of the serial-parallel configurations shown, relative to the impedance of the PV array in FIG. 7 (12 PV panels connected in parallel). Values of Zr range from Zr=1 in FIG. 7 to Zr=12 in FIG. 12. A method for adjusting PV array impedance is therefore based on selecting the combination of serial and parallel connections between intelligent nodes in a PV array that results in a discrete magnitude of change in PV array output voltage that is within a predictable maximum error of the magnitude of change in the impedance of an electrical load receiving power from the PV array.

FIG. 14 represents a variation of the method illustrated in FIG. 1. Numeric labels assigned to the steps in FIG. 14 indicate the corresponding steps in FIG. 1. In FIG. 14, the example of a method in accord with the invention begins with step 302. Next, in step 304, a power transfer objective is selected. The power transfer objective shown for the example of FIG. 13 is equalization of source impedance, i.e. PV array impedance, and load impedance.

Next, in steps 306-1 to 306-4, parameters related to the power transfer objective are assigned values. In step 306-1, a table of values of discrete changes in output voltage is calculated. The discrete changes in output voltage correspond to discrete changes in PV array impedance that may be selected for a configurable PV array.

Table 2 lists some of the discrete steps in PV array impedance, related to discrete steps in PV array output voltage as previously described, that can be produced by an example of a configurable PV array having 96 intelligent nodes. Table 2 shows the permutations of serial-parallel circuits that can be made from 96 intelligent nodes arranged into “J” groups of intelligent nodes, each group having “K” number of intelligent nodes in parallel and “J” number of groups electrically connected in series. The quantity Vs in Table 2 refers to the output voltage from one intelligent node. For the purposes of this example, Vs is the same for all the intelligent nodes in the configurable PV array.

TABLE 2
Discrete steps in output voltage from an example of a configurable
PV array with 96 intelligent nodes.

| No. of | No. of Intelligent | | |
|---|---|---|---|
| Serially- | Nodes Connected | | |
| Connected | in Parallel In Each | Impedance of PV | Normalized to Z for |
| Groups, J | Group, K | Array, Z | J = 12 and K = 8 |
| 1 | 96 | 1 | 0.08 |
| 2 | 48 | 2 | 0.17 |
| 3 | 32 | 3 | 0.25 |
| 4 | 24 | 4 | 0.33 |
| 6 | 16 | 6 | 0.50 |
| 8 | 12 | 8 | 0.67 |
| 12 | 8 | 12 | 1.0 |
| 16 | 6 | 16 | 1.3 |
| 24 | 4 | 24 | 2.0 |
| 32 | 3 | 32 | 2.7 |
| 48 | 2 | 48 | 4.0 |
| 96 | 1 | 96 | 8.0 |

The first data row in Table 2 refers to a single group of 96 intelligent nodes electrically connected in parallel, the second data row refers to two serially-connected groups with 48 intelligent nodes in parallel in each group, and so on. The bottom row in Table 2 refers to all 96 intelligent nodes electrically connected in series. The third column in Table 2, labeled “Impedance of PV Array, Z” refers to a value for array impedance relative to the impedance of an array consisting of one serially-connected group. Data in the third column of Table 2 is calculated using conventional methods for serial and parallel combinations of voltage sources, wherein the PV modules in the intelligent nodes correspond to the voltage sources. A difference between two values in the third column is related to a difference in impedance of the corresponding PV array configurations.

Table 2 does not include all the combinations of serial and parallel connections that could be formed in a configurable PV array having 96 intelligent nodes. For example, different groups of intelligent nodes in a configurable PV array may optionally have different numbers of intelligent nodes connected in parallel in each group, thereby changing the total number of groups that may be connected in series, and correspondingly changing the discrete intervals between configurable PV array output voltages. Or, two or more intelligent nodes may be placed in a serially-connected group, and serially-connected groups may then be interconnected in parallel. Table 2 may readily be expanded to include all such configurations by conventional calculation methods for serial and parallel circuit combinations. Table 2 may also be readily modified for configurable PV arrays having different numbers of intelligent nodes, including configurable PV arrays having hundreds of thousands of intelligent nodes. In general, the greater the number of intelligent nodes in a configurable PV array, the smaller the size of an incremental adjustment in output voltage, or alternately in PV array impedance, that may be achieved by reconfiguring serial and parallel connections, and the finer the degree of control that may be exercised in approaching a power control objective. The magnitude of an incremental adjustment in output voltage is related to a maximum amount of error in achieving a power transfer objective.

The fourth column in Table 2 shows a value of PV array impedance normalized to the configuration for 12 serially-connected groups with 8 intelligent nodes in parallel in each group. The fourth column could optionally be normalized against any of the other data rows in Table 2. For example, under reference conditions for incident illumination, temperature, and load impedance, maximum power from a configurable PV array to an electrical load may occur when the array is configured as 12 serially-connected groups with 8 intelligent nodes in parallel in each group. As load impedance increases, for example a doubling of load impedance, the configurable PV array would be switched to a configuration with twice as much impedance as the previous configuration, corresponding to 24 serially connected groups with four intelligent nodes in parallel in each group as shown in Table 2.

After calculating a table of values related to changes in impedance for selected combinations of serial and parallel connections between intelligent nodes (step 306-1 in FIG. 14), a value for load impedance is obtained in step 306-2. Many power generation systems, especially large ones, have means for determining load impedance, and means for communicating values for load impedance to a central monitoring and control computer. A baseline configuration for the PV array is selected in step 306-3, for example by configuring the array for a value of impedance closest to the current value of load impedance. Next, in step 306-4, the table of values related to discrete PV array impedance changes calculated in step 306-1 is optionally normalized to the current PV array configuration, thereby making it easier to select a discrete amount of increase or decrease in impedance relative to the baseline configuration in response to increases or decreases in load impedance.

In step 308, the configurable PV array is switched into the combination of serial and parallel connections between intelligent nodes determined in steps 306-1 to 306-4. Next, in step 310, a new value of load impedance is obtained and a magnitude of change in load impedance is calculated. In step 312, a determination is made as to whether the magnitude of change in load impedance places the new load impedance closer to the current PV array impedance or closer to the PV array impedance corresponding to another array configuration. If the magnitude of change in impedance is large enough, the PV array configuration is changed to a new configuration in step 314, otherwise the PV array configuration is left unchanged. That is, a determination is made as to whether the magnitude of change correlates more closely with the previous array configuration or with a new configuration. Another measurement and comparison cycle starts anew at step 310.

In general, a discrete amount of impedance change resulting from a change in serial and parallel connections in the configurable PV array will not exactly equal the amount of change in load impedance. Alternative steps in the example of FIG. 14 may therefore select either the next highest step in output voltage or the next lowest step, as preferred for a particular type of electrical load or other operating consideration. Commands for changing the connections between intelligent nodes could alternatively be issued from the central monitoring and control computer system or from a designated intelligent node. Switching commands could optionally be sent to all intelligent nodes simultaneously or propagated peer-to-peer, that is, from intelligent node to intelligent node.

FIG. 15 and FIG. 16 represent another variation of the method illustrated in FIG. 1. FIG. 16 is a continuation of the example from FIG. 15. The example of FIGS. 15-16 illustrates steps for implementing an example of a power transfer objective related to operating the configurable PV array at the maximum power point (MPP). Such a power transfer objective is useful, for example, for a configurable PV array supplying power to an electrical load having a relatively large input voltage range. In the method of FIGS. 15-16, the configuration of the PV array changes in response to changes in incident illumination, changes in temperature, or other changes that affect the current or voltage output of the PV array and therefore cause a change in the MPP.

In FIG. 15, the example begins with step 302. In step 304, a power transfer objective related to adapting the PV array configuration to track changes in MPP is selected. In step 306-1, a table of PV array output voltage values corresponding to selected PV array configurations is calculated. In step 306-2, a target value for configurable PV array output current is assigned, for example a target value related to array operation under specified conditions of illumination, temperature, and electrical load impedance. In step 306-3, values for MPP and a voltage value related to MPP at the target value of output current are determined. For example, a value of MPP may optionally be determined by maximizing the mathematical product of PV array output current from step 306-2 and a value of PV array output voltage under reference conditions of illumination and temperature, obtained from the table of step 306-1. In step 306-4, a combination of serial and parallel connections having an output voltage that gives a calculated output power value closest to the MPP value from step 306-3 is selected. In step 306-5, the table of PV array output voltages calculated in step 306-1 is optionally normalized to the array configuration selected in step 306-4.

After step 306-5, the example of FIG. 15 continues in FIG. 16 at step 308, in which the configurable PV array is switched into the combination of serial and parallel connections selected in step 306-4. Then, at step 310 in FIG. 16 a value of PV array output current is measured. A new value of MPP related to the new current value is calculated and compared to the previously determined MPP value in step 312. A determination is made in step 312 as to whether the magnitude of change in MPP impedance places the new MPP value closer to the current PV array configuration or closer to MPP calculated for the output voltage of another PV array configuration. If the magnitude of change in impedance is large enough, the PV array configuration is changed to a new configuration in step 314, otherwise the array configuration is left unchanged. Another measurement and comparison cycle starts anew at step 310.

One skilled in the art will appreciate that the method of FIG. 1 is applicable to many different power transfer objectives. For example, a power transfer objective of finding the optimum configuration of serial and parallel electrical connections between intelligent nodes for simultaneous changes in incident illumination and load impedance could be implemented by finding the configuration which most closely tracks a new value of MPP and at the same time minimizes a difference between source impedance and load impedance. Or, different power transfer objectives could be implemented sequentially in subsequent measurement and reconfiguration cycles (corresponding to steps 310-314 in FIG. 1). For example, a configurable PV array could first be configured to track MPP and next for matching source impedance and load impedance, in a repeating cycle.

Unless expressly stated otherwise herein, ordinary terms have their corresponding ordinary meanings within the respective contexts of their presentations, and ordinary terms of art have their corresponding regular meanings.

What is claimed is:

1. A method for configuring electrical connections between intelligent nodes in a photovoltaic array, comprising:
selecting a power transfer objective;
assigning values for one or more parameters related to the power transfer objective;
connecting the intelligent nodes in a first combination of serial and parallel electrical circuits selected according to the power transfer objective and the values of the parameters; and
measuring an amount of change in one or more of the parameters related to the power transfer objective.

2. The method for configuring electrical connections between intelligent nodes in a photovoltaic array of claim 1, further comprising:
determining if a measured amount of change in a parameter related to the power transfer objective correlates to a change of photovoltaic array configuration; and
connecting the intelligent nodes in a new combination of serial and parallel electrical circuits selected according to the power transfer objective and the measured amount of change in the parameter.

3. The method for configuring electrical connections between intelligent nodes in a photovoltaic array of claim 2, wherein the step of selecting a power transfer objective further comprises selecting an objective of outputting a voltage from the photovoltaic array that is within the input voltage range of an inverter.

4. The method for configuring electrical connections between intelligent nodes in a photovoltaic array of claim 3, wherein the step of assigning values to one or more parameters related the power transfer objective further comprises the step of computing a table of photovoltaic array output voltage values related to selected combinations of serial and parallel connections between intelligent nodes in a configurable photovoltaic array.

5. The method for configuring electrical connections between intelligent nodes in a photovoltaic array of claim 4, wherein the step of assigning values to one or more parameters related the power transfer objective further comprises the steps of:
obtaining values for the input voltage range of an inverter; and
selecting a baseline configuration for the photovoltaic array corresponding to a combination of serial and parallel electrical circuits having an output voltage within the input voltage range of the inverter.

6. The method for configuring electrical connections between intelligent nodes in a photovoltaic array of claim 5, further comprising the step of normalizing the table of photovoltaic array output voltage values to an output voltage value for the selected baseline configuration.

7. The method for configuring electrical connections between intelligent nodes in a photovoltaic array of claim 2, wherein the step of selecting a power transfer objective further comprises selecting an objective of equalizing photovoltaic array impedance and load impedance.

8. The method for configuring electrical connections between intelligent nodes in a photovoltaic array of claim 7, wherein the step of assigning values to one or more parameters related to the power transfer objective further comprises calculating values of impedance for selected combinations of serial and parallel connections between intelligent nodes in a configurable photovoltaic array.

9. The method for configuring electrical connections between intelligent nodes in a photovoltaic array of claim 8, wherein the step of assigning values to one or more parameters related the power transfer objective further comprises the steps of:
obtaining a value for load impedance; and
selecting a baseline configuration for the photovoltaic array corresponding to a combination of serial and parallel electrical circuits having a calculated value of impedance closer to the value of load impedance than the values of impedance calculated for other combinations.

10. The method for configuring electrical connections between intelligent nodes in a photovoltaic array of claim 9, further comprising the step of normalizing the calculated values of impedance to a value of impedance for the selected baseline configuration.

11. The method for configuring electrical connections between intelligent nodes in a photovoltaic array of claim 2, wherein the step of selecting a power transfer objective further comprises selecting an objective of outputting electrical power from a photovoltaic array at a maximum power point.

12. The method for configuring electrical connections between intelligent nodes in a photovoltaic array of claim 11, wherein the step of assigning values to one or more parameters related to the power transfer objective further comprises calculating values of photovoltaic array output voltage for selected combinations of serial and parallel electrical connections between intelligent nodes in a configurable photovoltaic array.

13. The method for configuring electrical connections between intelligent nodes in a photovoltaic array of claim 12, wherein the step of assigning values to one or more parameters related to the power transfer objective further comprises the step of assigning a target value for photovoltaic array output current.

14. The method for configuring electrical connections between intelligent nodes in a photovoltaic array of claim 13, wherein the step of assigning values to one or more parameters related to the power transfer objective further comprises the step of specifying reference conditions for incident illumination and temperature.

15. The method for configuring electrical connections between intelligent nodes in a photovoltaic array of claim 14, wherein the target value for photovoltaic array output current is related to the specified reference conditions for incident illumination and temperature.

16. The method for configuring electrical connections between intelligent nodes in a photovoltaic array of claim 15, wherein the step of assigning values to one or more parameters related to the power transfer objective further comprises the steps of:
determining a value for a maximum power point related to the target value for photovoltaic array output current; and
determining a value for photovoltaic array output voltage at the maximum power point.

17. The method for configuring electrical connections between intelligent nodes in a photovoltaic array of claim 16, wherein the step of assigning values to one or more parameters related to the power transfer objective further comprises the step of selecting a baseline configuration for the photovoltaic array corresponding to a combination of serial and parallel electrical circuits having a value of photovoltaic array output voltage closer to the photovoltaic array output voltage at the maximum power point than the values of photovoltaic array output voltage calculated for other combinations.

18. The method for configuring electrical connections between intelligent nodes in a photovoltaic array of claim 17, wherein the step of assigning values to one or more parameters related to the power transfer objective further comprises the step of normalizing the calculated values of photovoltaic array output voltage to the value of photovoltaic array output voltage for the selected baseline configuration.

19. The method for configuring electrical connections between intelligent nodes in a photovoltaic array of claim 18, wherein the step of measuring an amount of change in one or more of the parameters related to the power transfer objective further comprises the steps of:
measuring a new value of photovoltaic array output current;
determining a value for a new maximum power point related to the new value of photovoltaic array output current; and
determining a new value of photovoltaic array output voltage at the value of the new maximum power point.

20. The method for configuring electrical connections between intelligent nodes in a photovoltaic array of claim 19, wherein the step of determining if a measured amount of change in a parameter related to the power transfer objective correlates to a change of photovoltaic array configuration further comprises the steps of:
determining a magnitude of change in the value of the maximum power point; and
determining if the magnitude of change in the value of the maximum power point correlates with another photovoltaic array configuration.
